(19) United States
(12) Patent Application Publication
(10) Pub. No.: US 2014/0021083 A1
(43) Pub. Date: Jan. 23, 2014

(54) MULTIFUNCTION MEDICINE CHEST

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventor: LIN LIU, Shenzhen (CN)

(21) Appl. No.: 13/927,450

(22) Filed: Jun. 26, 2013

(30) Foreign Application Priority Data
Jul. 18, 2012 (CN) 2012102484096

(51) Int. Cl. A61J 1/00

(52) U.S. Cl. CPC A61J 1/00
USPC 206/438

(57) ABSTRACT

A multifunction medicine chest includes a chest, a door set at one side of the chest to open and close the chest and a control device. The chest is configured to store medicines and includes a plurality of drawers. Each drawer corresponds to one category of medicines. The control device includes an input unit, a storage unit, and a control unit. When a user stores a medicine into the chest, the input unit obtains medicine information of the medicine and transmits the medicine information to the control unit, the control unit determines the category of the medicine and a number of the drawer for the medicine and generates storage information of the medicine. When the user takes the medicine out of the chest, the input unit obtains portion medicine information of the medicine, the control unit searches for the storage information.

### BACKGROUND

1. Technical Field

The disclosure generally relates to multifunction medicine chests, and particularly to a multifunction medicine chest, which is convenient for users to search for medicine.

2. Description of Related Art

Conventional medicine chests commonly have a single function to store medicine. When the medicine is stored in the medicine chests, it is inconvenient for users to reach for some medicines needed.

In addition, when the medicine chest is filled with too much medicine, some expired medicines cannot be timely discovered. The expired medicines not only waste space inside the medicine chest but also can be easily mistaken by the users.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the disclosure.

FIG. 1 is a schematic view of a multifunction medicine chest, according to an exemplary embodiment of the disclosure.

FIG. 2 is a block diagram of the multifunction medicine chest of FIG. 1.

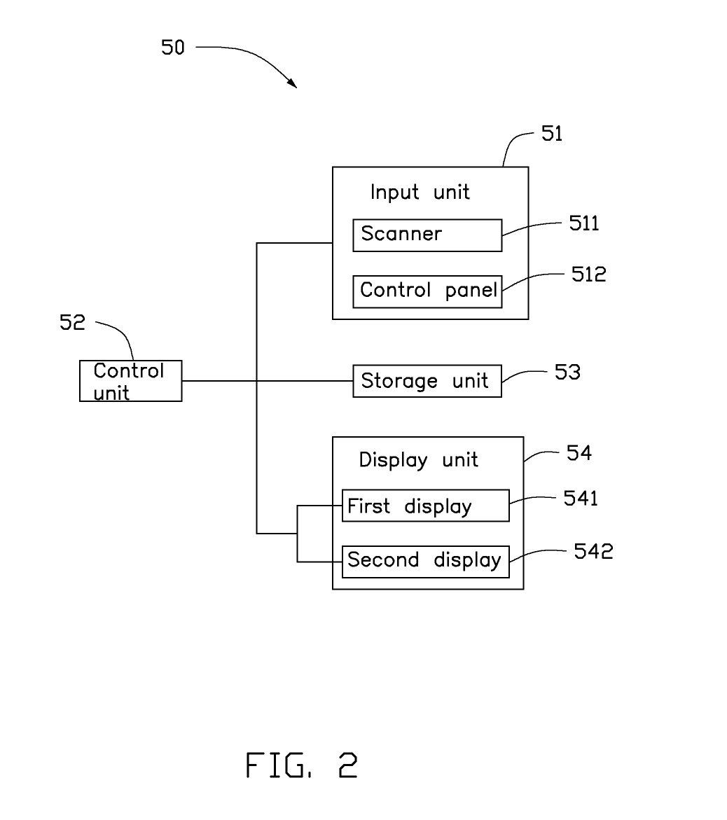

### DETAILED DESCRIPTION

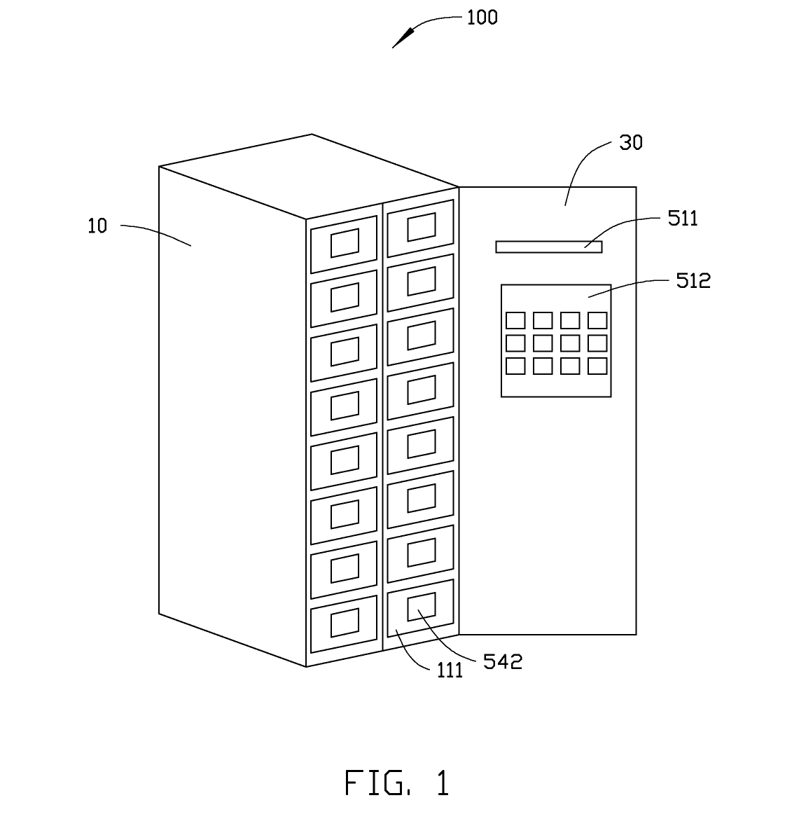

FIG. 1 is a schematic view of a multifunction medicine chest 100, according to an exemplary embodiment of the disclosure. The medicine chest 100 is configured to store medicine, manage the stored medicine in categories, and timely send a reminder of expired medicine. The multifunction medicine chest 100 includes a chest 10, a door 30, and a control device 50 mounted in the chest 10.

The chest 10 is substantially a rectangular cabinet including a plurality of drawers 111. Each drawer 111 is configured to store one corresponding category of medicine, such as cold medicine, cough medicine, emergency medicine, for example. The drawer 111 can be distinguished from each other by a unique number.

The door 30 is rotatably set at one side of the chest 10 and configured to open and close the chest 10.

The control device 50 includes an input unit 51, a control unit 52, a storage unit 53, and a display unit 54. The control unit 52 is electrically connected to the input unit 51, the storage unit 53, and the display unit 54.

The input unit 51 includes a scanner 511 and a control panel 512. The scanner 511 is configured to obtain medicine information such as a medicine name, an expiry date, for example by scanning tags of the medicine and transmit the medicine information to the control unit 52 when a user stores the medicine into the chest 10. The control panel 512 is configured to input a portion of the medicine information such as the medicine name and transmit the input medicine information to the control unit 52.

The control unit 52 determines which category of the medicine belongs to and which drawer 111 corresponds to the category of the medicine according to the medicine information when the user stores the medicine into the chest 10 and compiles related storage information, which comprises the medicine information, the category, and the number of the drawer 111. The control unit 52 also transmits the storage information to the display unit 54 to indicate the user.

Meanwhile, when the user needs medicine from the chest 10, the control unit 52 searches for the storage information, according to the portion of the medicine information input by the user and transmits the storage information to the display unit 54 to location position to the user. Thus, the user can conveniently take the needed medicine out of the chest 10. In addition, when the user takes out one category of medicine from the chest 10, the storage information of this category of medicines and sorts the searched medicines according to the expiry dates is searched. Therefore, the user can take the medicine having an earlier expiry date of the chest 10.

The storage unit 53 is configured to store the storage information of the medicines.

The display unit 54 includes a first display 541 positioned outside of the door 30 and a plurality of a second displays 542 correspondingly positioned on the drawers 111. The first display 541 is configured to display the storage information of the medicines during the processes that the user stores the medicine into the drawers 11 or takes the medicine out of the drawers 111. Each second display 542 is configured to display the category of the medicine corresponding to the drawer 111.

When the user stores the medicine into the chest 10, the scanner 511 obtains the medicine information such as the medicine name, the expiry date, for example and transmits the medicine information to the control unit 52. The control unit 52 determines which category of the medicine belongs to and which drawer 111 corresponds to the category of the medicine according to the medicines information and generates the storage information, which comprises the medicine information, the category, and the number of the drawer 111. The control unit 52 controls the storage unit 53 to store the storage information and controls the first display 541 to display the storage information.

When the user takes the medicine out of the chest 10, the user inputs the portion of the medicine information via the control panel 512. The control unit 52 searches for the storage information in the storage unit 53 according to the portion of the medicine information input by the user.

In addition, the control unit 52 can monitor expiry dates of the medicine. When a medicine has expired, the control unit 52 can use the first display 541 to display the storage information indicating that the chest 10 contains expired medicine and the identification of the drawers 111 containing the expired medicine. Therefore, the user can timely deal with the expired medicine to avoid wasting space in the chest 10 and being mistakenly used.

In other embodiments, it is merely needed to ensure that the category displayed by the second display 542 matches with the category of the medicine actually stored in the drawer 111. The number of the drawer 111 corresponding to each category of medicine can be designated by the control unit 52 and can be set by the user via using the control panel 512.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A multifunction medicine chest, comprising:
a chest configured to store medicines, the chest comprising a plurality of drawers, each drawer corresponding to one category of medicines;
a door for opening and closing the chest; and
a control device mounted in the chest, the control device comprising an input unit, a storage unit, a display unit, and a control unit connected to the input unit, the storage unit, and the display unit; wherein when a user stores a medicine in the chest body, the input unit obtains medicine information of the medicine and transmits the medicine information to the control unit, the control unit determines the category of the medicine and a number of the drawer used to store the medicine and generates storage information which comprises the medicine information, the category, and the number of the drawer of the medicine, the control unit controls the storage unit to store the storage information and controls the display unit to display the storage information; when the user takes the medicine out of the chest, the input unit obtains portion medicine information of the medicine, the control unit searches for the storage information according to the portion of the medicine information in the storage unit, and controls the display unit to display the storage information.

2. The multifunction medicine chest of claim 1, wherein the input unit comprises a scanner and the control panel, the scanner is configured to obtain the medicine information of the medicine to be stored in the chest and transmits the medicine information to the control unit; the control panel is configured to input portion of the medicine information and transmit the input medicine information to the control unit.

3. The multifunction medicine chest of claim 2, wherein the display unit comprises a first display positioned outside the door to display the storage information.

4. The multifunction medicine chest of claim 3, wherein the display unit further comprises a plurality of second displays corresponding to the drawers, each drawer is positioned outside one of the drawers to display the category of the corresponding drawer.

5. The multifunction medicine chest of claim 1, wherein the control unit designates the category of each drawer.

6. The multifunction medicine chest of claim 1, wherein the medicine information comprises the expiry dates of the medicines, the control unit monitors the expiry dates of the medicines, when some of the medicines are expired, the control unit controls the display unit to display the location/content<?> of expired medicines.

7. The multifunction medicine chest of claim 1, wherein the storage information comprises the medicine information, the category, and the number of the drawer of the medicine.

8. A multifunction medicine chest, comprising:
a chest configured to store medicines, the chest comprising a plurality of drawers, each drawer corresponding to one category of medicines;
a door for opening and closing the chest; and
a control device comprising:
a storage unit stored medicine information of the medicines, the medicine information comprising an expiry date of the medicines;
a display unit; and
a control unit connected to the storage unit and the display unit; the control unit monitors the expiry dates of the medicines, when some of the medicines are expired, the control unit controls the display unit to display the location/content expired medicines.

9. The multifunction medicine chest of claim 8, further comprising an input unit, wherein the input unit obtains one category of medicine to be taken out of the chest, the control unit searches for the storage information of this category of medicines and sorts the searched medicines according to the expiry dates.

10. The multifunction medicine chest of claim 8, wherein the storage information comprises the medicine information, the category, and the number of the drawer of the medicine.

11. The multifunction medicine chest of claim 8, wherein the display unit comprises a first display positioned outside the door to display the storage information.

12. The multifunction medicine chest of claim 11, wherein the display unit further comprises a plurality of second displays corresponding to the drawers, each drawer is positioned outside one of the drawers to display the category of the corresponding drawer.

13. The multifunction medicine chest of claim 8, wherein the control unit designates the category of each drawer.
